(19) United States
(12) Patent Application Publication
(10) Pub. No.: US 2021/0005963 A1
(43) Pub. Date: Jan. 7, 2021

(54) ANTENNA APPARATUS

(71) Applicant: Mitsubishi Electric Corporation, Chiyoda-ku (JP)

(72) Inventor: Hiroshi IKEMATSU, Chiyoda-ku (JP)

(73) Assignee: Mitsubishi Electric Corporation, Chiyoda-ku (JP)

(21) Appl. No.: 16/906,161

(22) Filed: Jun. 19, 2020

(30) Foreign Application Priority Data
Jul. 3, 2019 (JP) 2019-124093

(51) Int. Cl. H01Q 3/08; H01Q 1/12

(52) U.S. Cl. CPC H01Q 3/08; H01Q 1/125

(57) ABSTRACT

An antenna apparatus includes an azimuth angle axis fixed to a base and serving as a rotation axis rotating in an azimuth angle direction, a supporting column rotating in the azimuth angle direction about the azimuth angle axis, and a first elevation angle axis fixed with respect to the supporting column and serving as a rotation axis rotating in an elevation angle direction. The antenna apparatus further includes an aperture antenna having a reflecting mirror to rotate in the elevation angle direction about the first elevation angle axis, and an AESA antenna opposite to the first elevation angle axis with the supporting column interposed. The AESA antenna is farther away from the base than the first elevation angle axis is in a vertical direction which is a direction in which the azimuth angle axis extends.

### BACKGROUND OF THE INVENTION

### Field of the Invention

The present disclosure relates to an antenna apparatus for satellite communication.

### Description of the Background Art

A satellite communication system in which high speed data communication is performed with a plurality of low earth orbit (LEO) satellites employs an antenna apparatus capable of transmitting and receiving electric waves to and from the LEO satellites simultaneously without interfering with each other (see Japanese Patent No. 3313636 for example).

Japanese Patent No. 3313636 describes an antenna system that mechanically tracks LEO satellites by using two offset aperture antennas separated by a predetermined distance. The antenna system mechanically tracks the LEO satellites by fixing a primary feed of each of the two aperture antennas and rotating a reflector about an azimuth angle axis and an elevation angle axis toward an LEO satellite. The document indicates that this allows each aperture antenna to track an LEO satellite.

When a mobile object including an aircraft is equipped with a communication device that communicates with a plurality of low earth orbit satellites, an antenna apparatus is required to have a function to transmit and receive electric waves to and from each satellite simultaneously, and is also required to be reduced in height to reduce an effect on the aircraft's aerodynamic characteristics.

In a system using a plurality of aperture antennas developed as a multi-beam antenna, such as the antenna system described in Japanese Patent No. 3313636, due to constraints of the driving mechanism of the system, it has been impossible to track a plurality of satellites at high speed. Furthermore, when the system is mounted on an aircraft, due to mechanical constraints for mounting the system on a surface of the aircraft, it has been difficult to direct a plurality of beams in desired directions.

In contrast, it is also possible to compose a multi-beam antenna of an active electronically scanned array (AESA) antenna. A known AESA antenna is in a digital beam forming (DBF) system in which a digital-to-analog converter (DAC) or an analog-to-digital converter (ADC) is connected to each antenna element and a digital signal is used to perform a beam scanning process. The AESA antenna in the DBF system consumes large power and also requires for each element a frequency conversion circuit before inputting to the DAC or the ADC, which increases the size and hence cost of the antenna apparatus.

The present disclosure has been made in view of the above-described circumstances, and contemplates a miniaturized and inexpensive antenna apparatus capable of directing a plurality of antennas to a plurality of satellites at high speed without interfering with each other.

### SUMMARY OF THE INVENTION

To achieve the above object, an antenna apparatus according to the present disclosure includes an azimuth angle axis fixed to a base and serving as a rotation axis rotating in an azimuth angle direction, a supporting column rotating in the azimuth angle direction about the azimuth angle axis, and a first elevation angle axis fixed with respect to the supporting column and serving as a rotation axis rotating in an elevation angle direction. The antenna apparatus further includes an aperture antenna having a reflecting mirror to rotate in the elevation angle direction about the first elevation angle axis, and an AESA antenna opposite to the first elevation angle axis with the supporting column interposed. The AESA antenna is characterized by being farther away from the base than the first elevation angle axis is in a vertical direction which is a direction in which the azimuth angle axis extends.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an external appearance of an antenna apparatus according to a first embodiment of the present disclosure.

FIG. 2 is a side view of the antenna apparatus.

FIG. 3 is a side view of the antenna apparatus when an AESA antenna is rotated.

FIG. 4 shows an external appearance of an antenna apparatus according to a second embodiment of the present disclosure.

### DESCRIPTION OF THE PREFERRED EMBODIMENTS

### First Embodiment

Hereinafter, embodiments for implementing the present disclosure will be described in detail with reference to the drawings. In the figures, identical or equivalent components are identically denoted.

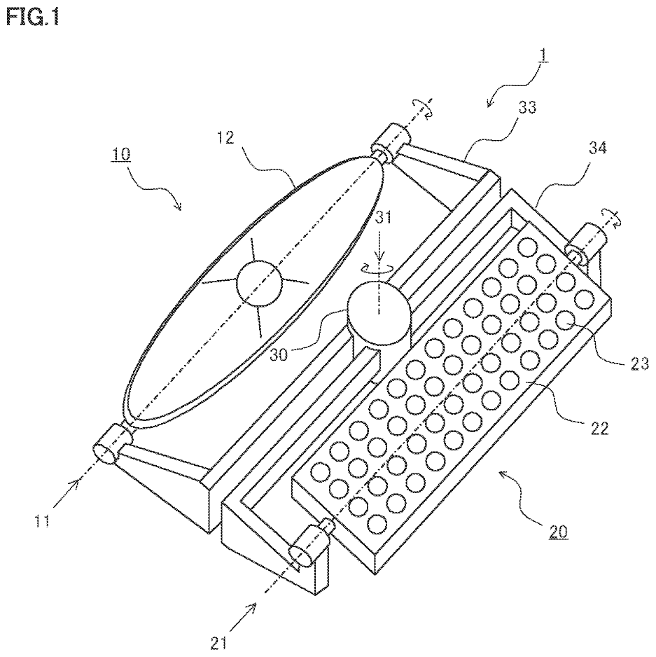

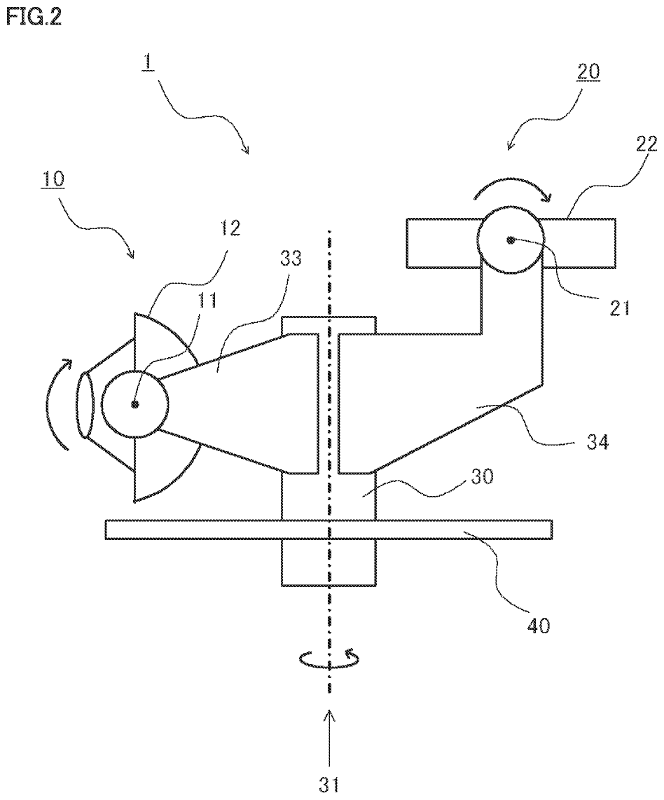

FIG. 1 shows an external appearance of an antenna apparatus 1 according to an embodiment of the present disclosure. FIG. 2 is a side view of antenna apparatus 1. Antenna apparatus 1 is installed on a mobile object and communicates with a plurality of artificial satellites.

As shown in FIG. 1, antenna apparatus 1 includes an aperture antenna 10 and an active electronically scanned array (AESA) antenna 20 supported by a supporting column 30. As shown in FIG. 2, supporting column 30 is mechanically driven to rotate about an azimuth angle axis 31 fixed to base 40. Azimuth angle axis 31 is also referred to as an AZ (azimuth) axis, and is, for example, an axis extending in a direction perpendicular to a direction in which base 40 extends. Supporting column 30 rotates in a direction, which is the azimuth angle direction of antenna apparatus 1. In FIG. 1, base 40 is not shown.

Aperture antenna 10 includes a reflecting mirror 12 that rotates about a first elevation angle axis 11 that extends in a horizontal direction perpendicular to azimuth angle axis 31. Reflecting mirror 12 may have any shape, and, for example, it has an elliptical aperture and has a shape with a parabolic cross section in a plane perpendicular to first elevation angle axis 11. First elevation angle axis 11 is an axis fixed with respect to supporting column 30, and supported by a supporter 33 extending from supporting column 30. Reflecting mirror 12 rotates a direction in which aperture antenna 10 is directed about first elevation angle axis 11 by mechanical driving, and the direction of the rotation is the elevation angle direction of aperture antenna 10.

AESA antenna 20 is opposite to first elevation angle axis 11 with supporting column 30 posed therebetween, and is installed along a second elevation angle axis 21 extending in a horizontal direction perpendicular to azimuth angle axis 31. Second elevation angle axis 21 is an axis fixed with respect to supporting column 30, and is supported by a supporter 34 extending from supporting column 30. AESA antenna 20 is an array antenna in which a plurality of antenna elements 23 are two-dimensionally arranged on an AESA panel 22.

Here, first elevation angle axis 11 and second elevation angle axis 21 are also referred to as an elevation (EL) axis as they are rotation axes in the elevation angle direction of antenna apparatus 1. First elevation angle axis 11 and second elevation angle axis 21 are opposite to each other with supporting column 30 posed therebetween, and they are parallel to each other and are isolated from each other.

AESA antenna 20 performs electronic scanning in a two-dimensional direction by controlling a phase of a signal that each antenna element 23 transmits/receives. In the first embodiment, in addition to the electronic scanning, AESA antenna 20 has AESA panel 22 mechanically driven to rotate in the elevation angle direction about second elevation angle axis 21 so that AESA antenna 20 has a changed elevation angle.

Mechanically driving supporting column 30 in the azimuth angle direction, mechanically driving aperture antenna 10 in the elevation angle direction, and mechanically driving AESA antenna 20 in the elevation angle direction are controlled independently of one another by an antenna controlling computer. The antenna controlling computer also controls the two-dimensional electronic scanning performed by AESA antenna 20.

Note that second elevation angle axis 21 that is the rotation axis of AESA antenna 20 is farther away from base 40 than first elevation angle axis 11 that is the rotation axis of aperture antenna 10 is in a vertical direction which is a direction in which azimuth angle axis 31 extends. That is, when a direction away from base 40 is referred to as a direction in level, AESA antenna 20 is installed at a position higher in level than aperture antenna 10.

Furthermore, as shown in FIG. 2, when aperture antenna 10 has reflecting mirror 12 directed in a direction with an elevation angle of 0°, AESA antenna 20 is behind a back surface of reflecting mirror 12. Further, reflecting mirror 12 of aperture antenna 10 and AESA panel 22 of AESA antenna 20 are separated from each other in a direction along a surface of base 40. That is, when viewed toward base 40 in a direction in which azimuth angle axis 31 extends, reflecting mirror 12 of aperture antenna 10 and AESA panel 22 of AESA antenna 20 do not overlap.

How antenna apparatus 1 configured as described above operates will now be described. Herein, an example in which a mobile object is an aircraft and antenna apparatus 1 is mounted on the aircraft will be described. Antenna apparatus 1 has base 40 fixed to the aircraft.

Supporting column 30 by which aperture antenna 10 and AESA antenna 20 are supported rotates in the azimuth angle direction about azimuth angle axis 31. Aperture antenna 10 rotates from an elevation angle of 0° to an elevation angle of 90° or larger about first elevation angle axis 11. AESA antenna 20 rotates from an elevation angle of 0° to an elevation angle of 90° or larger about second elevation angle axis 21 and also performs electronic scanning. Thus, aperture antenna 10 and AESA antenna 20 can both be directed to a low elevation angle such as 0 to 20°, and thus also be directed to a low earth orbit (LEO) satellite.

Aperture antenna 10 and AESA antenna 20 can capture two different satellites simultaneously. For example, while the aircraft is moving, aperture antenna 10 captures and tracks a first satellite. However, it is necessary to perform a handover to switch satellites to communicate before aperture antenna 10 can no longer track the first satellite. In doing so, while aperture antenna 10 captures the first satellite, AESA antenna 20 captures a second satellite.

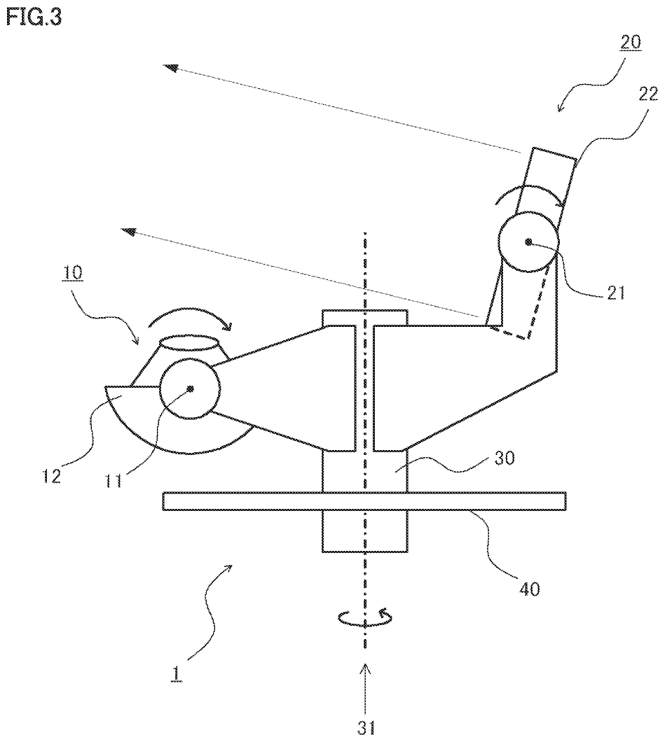

Note that second elevation angle axis 21 that is the rotation axis of AESA antenna 20 is farther away from base 40 than first elevation angle axis 11 that is the rotation axis of aperture antenna 10 is, and accordingly, AESA antenna 20 is located at a position higher in level than aperture antenna 10. Therefore, as shown in FIG. 3, even when AESA antenna 20 is significantly inclined with respect to base 40 and directed to a satellite at a low elevation angle, aperture antenna 10 never interrupts a beam of AESA antenna 20. In other words, an antenna beam of AESA antenna 20 passes above the upper end of aperture antenna 10.

Furthermore, as reflecting mirror 12 of aperture antenna 10 and AESA panel 22 of AESA antenna 20 do not overlap in a direction along base 40, and a beam of aperture antenna 10 is not interrupted by AESA panel 22, either.

The rotation of aperture antenna 10 and the rotation of AESA antenna 20 are controlled independently of each other, and furthermore, AESA antenna 20 performs electronic scanning in addition to mechanical driving, so that the antennas can be directed fast and accurately. This allows a handover to be performed smoothly. Furthermore, a simple structure with AESA antenna 20 disposed at a position slightly higher in level than aperture antenna 10 allows antenna apparatus 1 to be generally miniaturized and reduced in cost.

As has been described above, antenna apparatus 1 according to the present embodiment includes supporting column 30 rotating about azimuth angle axis 31 fixed to base 40, and further includes aperture antenna 10 having reflecting mirror 12 rotating about first elevation angle axis 11 fixed with respect to supporting column 30, and AESA antenna 20 having AESA panel 22 rotating about second elevation angle axis 21 fixed with respect to supporting column 30. Second elevation angle axis 21 is farther away from base 40 than first elevation angle axis 11 is in a vertical direction which is a direction in which azimuth angle axis 31 extends. Thus, aperture antenna 10 and AESA antenna 20 can be directed to a plurality of satellites at high speed without interfering with each other.

### Second Embodiment

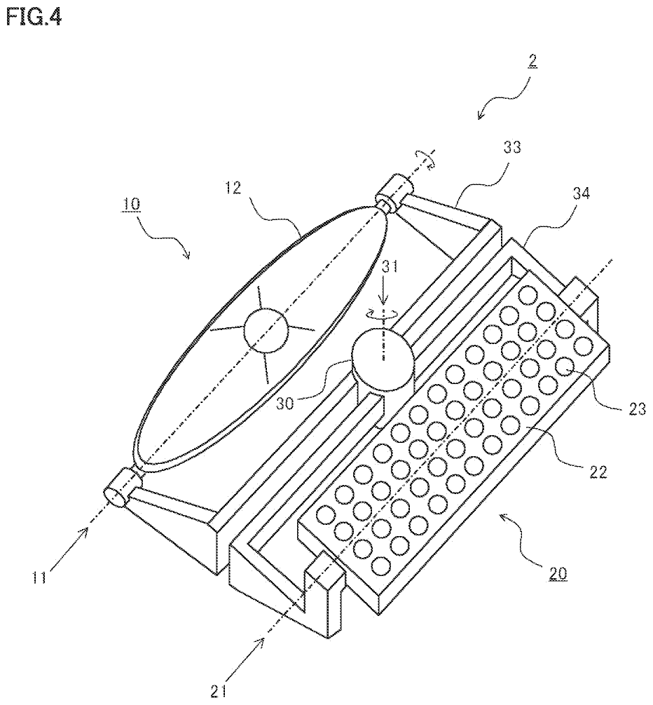

FIG. 4 shows an external appearance of an antenna apparatus 2 according to a second embodiment of the present disclosure. Antenna apparatus 2 is installed on a mobile object and communicates with a plurality of artificial satellites.

As shown in FIG. 4, antenna apparatus 2 includes aperture antenna 10 and AESA antenna 20 supported by supporting column 30. Supporting column 30 and aperture antenna 10 are similar in configuration and operation to those of the first embodiment.

AESA antenna 20 is opposite to first elevation angle axis 11 with supporting column 30 interposed, and is installed along second elevation angle axis 21 extending in a horizontal direction perpendicular to azimuth angle axis 31. Second elevation angle axis 21 is an axis fixed with respect to supporting column 30, and is supported by supporter 34 extending from supporting column 30. AESA antenna 20 is an array antenna in which a plurality of antenna elements 23 are two-dimensionally arranged on AESA panel 22. AESA antenna 20 has AESA panel 22 fixed to supporting column 30 while extending in a horizontal direction perpendicular to azimuth angle axis 31. That is, when azimuth angle axis 31 is perpendicular to a direction in which the base extends, AESA panel 22 extends in a direction parallel to base 40. In FIG. 4, base 40 is not shown.

AESA antenna 20 performs electronic scanning in a two-dimensional direction by controlling a phase of a signal that each antenna element 23 transmits/receives. In the second embodiment, AESA antenna 20 changes its elevation angle by electronic scanning alone.

Mechanically driving supporting column 30 in the azimuth angle direction, mechanically driving aperture antenna 10 in the elevation angle direction, and two-dimensional electronic scanning performed by AESA antenna 20 are controlled by an antenna controlling computer.

Note that second elevation angle axis 21 along which AESA antenna 20 is installed is farther away from base 40 than first elevation angle axis 11 that is the rotation axis of aperture antenna 10 is in a vertical direction which is a direction in which azimuth angle axis 31 extends. That is, when a direction away from base 40 is referred to as a direction in level, AESA antenna 20 is installed at a position higher in level than aperture antenna 10.

Further, reflecting mirror 12 of aperture antenna 10 and AESA panel 22 of AESA antenna 20 are separated from each other in a direction along a surface of base 40. That is, when viewed toward base 40 in a direction in which azimuth angle axis 31 extends, reflecting mirror 12 of aperture antenna 10 and AESA panel 22 of AESA antenna 20 do not overlap.

Antenna apparatus 2 configured as described above is similar in operation to the first embodiment, and differs from the first embodiment only in that AESA antenna 20 tracks a satellite by electronic scanning alone. For example, while an aircraft having antenna apparatus 2 installed thereon is moving, aperture antenna 10 captures and tracks a first satellite. However, it is necessary to perform a handover to switch satellites to communicate before aperture antenna 10 can no longer track the first satellite. In doing so, while aperture antenna 10 captures the first satellite, AESA antenna 20 captures a second satellite by electronic scanning.

The second embodiment is also such that second elevation angle axis 21 along which AESA antenna 20 is installed is farther away from base 40 than first elevation angle axis 11 that is the rotation axis of aperture antenna 10 is, and accordingly, AESA antenna 20 is located at a position higher in level than aperture antenna 10. Therefore, aperture antenna 10 never interrupts a beam of AESA antenna 20.

Furthermore, as reflecting mirror 12 of aperture antenna 10 and AESA panel 22 of AESA antenna 20 do not overlap in a direction along base 40, and a beam of aperture antenna 10 is not interrupted by AESA panel 22, either.

Thus, antenna apparatus 2 according to the present embodiment has AESA antenna 20 fixed to second elevation angle axis 21 farther away from base 40 than first elevation angle axis 11 that is the rotation axis of aperture antenna 10. A simpler configuration can thus be employed to direct two antennas to a plurality of satellites at high speed without interfering with each other.

Thus according to the present disclosure an antenna apparatus includes an azimuth angle axis fixed to a base and serving as a rotation axis rotating in an azimuth angle direction, a supporting column rotating in the azimuth angle direction about the azimuth angle axis, and a first elevation angle axis fixed with respect to the supporting column and serving as a rotation axis rotating in an elevation angle direction. The antenna apparatus further includes an aperture antenna having a reflecting mirror to rotate in the elevation angle direction about the first elevation angle axis, and an AESA antenna opposite to the first elevation angle axis with the supporting column interposed. The AESA antenna is characterized by being farther away from the base than the first elevation angle axis is in a vertical direction which is a direction in which the azimuth angle axis extends. This can implement a miniaturized and inexpensive antenna apparatus capable of directing a plurality of antennas to a plurality of satellites at high speed without interfering with each other.

Note that the present disclosure is not limited to the above-described embodiments, and various modifications can be made as a matter of course without departing from the spirit of the present disclosure.

For example, while in the above embodiments aperture antenna 10 is provided with reflecting mirror 12 having an elliptical aperture, it may be an aperture antenna including a reflecting mirror of any shape. For example, the reflecting mirror may be a reflecting mirror having a circular aperture, or a longitudinally curved, laterally elongate reflecting mirror disclosed in Japanese Patent Laying-Open No. 2016-82370.

Further, while AESA antenna 20 is configured to have antenna elements 23 arranged on AESA panel 22 two-dimensionally, AESA antenna 20 may be configured to have antenna elements 23 arranged on AESA panel 22 one-dimensionally. In that case, antenna elements 23 may be arranged parallel to second elevation angle axis 21.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An antenna apparatus comprising:
an azimuth angle axis fixed to a base and serving as a rotation axis rotating in an azimuth angle direction;
a supporting column rotating in the azimuth angle direction about the azimuth angle axis;
a first elevation angle axis fixed with respect to the supporting column and serving as a rotation axis rotating in an elevation angle direction;
an aperture antenna having a reflecting mirror to rotate in the elevation angle direction about the first elevation angle axis; and
an active electronically scanned array (AESA) antenna opposite to the first elevation angle axis with the supporting column interposed,
the AESA antenna being farther away from the base than the first elevation angle axis is in a vertical direction which is a direction in which the azimuth angle axis extends.

2. The antenna apparatus according to claim 1, further comprising a second elevation angle axis fixed at a position opposite to the first elevation angle axis with the supporting column interposed, and serving as a rotation axis to rotate in the elevation angle direction, wherein
the AESA antenna has an AESA panel to rotate in the elevation angle direction about the second elevation angle axis, and has antenna elements arranged along a surface of the AESA panel, and
the second elevation angle axis is farther away from the base in the vertical direction than the first elevation angle axis is.

3. The antenna apparatus according to claim 2, wherein rotation of the reflecting mirror about the first elevation angle axis and rotation of the AESA panel about the second elevation angle axis are controlled independently of each other.

4. The antenna apparatus according to claim 1, wherein the AESA antenna is fixed with respect to the supporting column, has an AESA panel extending in a horizontal direction perpendicular to the azimuth angle axis, and has antenna elements arranged along a surface of the AESA panel.

5. The antenna apparatus according to claim 1, wherein an antenna beam of the AESA antenna passes above an upper end of the aperture antenna.

6. The antenna apparatus according to claim 2, wherein an antenna beam of the AESA antenna passes above an upper end of the aperture antenna.

7. The antenna apparatus according to claim 3, wherein an antenna beam of the AESA antenna passes above an upper end of the aperture antenna.

8. The antenna apparatus according to claim 4, wherein an antenna beam of the AESA antenna passes above an upper end of the aperture antenna.

9. The antenna apparatus according to claim 1, wherein the reflecting mirror of the aperture antenna has an elliptical or circular aperture or has a longitudinally curved, laterally elongate shape.

10. The antenna apparatus according to claim 2, wherein the reflecting mirror of the aperture antenna has an elliptical or circular aperture or has a longitudinally curved, laterally elongate shape.

11. The antenna apparatus according to claim 3, wherein the reflecting mirror of the aperture antenna has an elliptical or circular aperture or has a longitudinally curved, laterally elongate shape.

12. The antenna apparatus according to claim 4, wherein the reflecting mirror of the aperture antenna has an elliptical or circular aperture or has a longitudinally curved, laterally elongate shape.

13. The antenna apparatus according to claim 5, wherein the reflecting mirror of the aperture antenna has an elliptical or circular aperture or has a longitudinally curved, laterally elongate shape.

14. The antenna apparatus according to claim 6, wherein the reflecting mirror of the aperture antenna has an elliptical or circular aperture or has a longitudinally curved, laterally elongate shape.

15. The antenna apparatus according to claim 7, wherein the reflecting mirror of the aperture antenna has an elliptical or circular aperture or has a longitudinally curved, laterally elongate shape.

16. The antenna apparatus according to claim 8, wherein the reflecting mirror of the aperture antenna has an elliptical or circular aperture or has a longitudinally curved, laterally elongate shape.
